(19) United States
(12) Patent Application Publication
(10) Pub. No.: US 2010/0205603 A1
(43) Pub. Date: Aug. 12, 2010

(54) SCHEDULING AND DISPATCHING TASKS IN AN EMULATED OPERATING SYSTEM

(75) Inventors: James F Merten, Shoreview, MN (US); Michael J. Rieschl, St. Paul, MN (US); Nathan T. Zimmer, Hudson, WI (US)

Correspondence Address: UNISYS CORPORATION, UNISYS WAY, MAIL STATION: S1-108, BLUE BELL, PA, 19424, US

(73) Assignee: Unisys Corporation

(21) Appl. No.: 12/367,921

(22) Filed: Feb. 9, 2009

(51) Int. Cl. G06F 9/46

(52) U.S. Cl. 718/100

(57) ABSTRACT

Approaches for dispatching routines in an emulated operating system. A method includes executing a first operating system (OS) on an instruction processor of a data processing system. The first OS includes instructions of a first instruction set that are native to the instruction processor. A second OS is emulated on the first OS and includes instructions of a second instruction set that are not native to the instruction processor. A first plurality of tasks is created by the emulated second OS. The first OS individually schedules the first plurality of tasks and dispatches the first plurality of emulated tasks for emulation according to the scheduling.

### FIELD OF THE INVENTION

The present invention generally relates to emulating operating systems.

### BACKGROUND

In the past, software applications that required a large degree of data security and recoverability were traditionally supported by mainframe data processing systems. Such software applications may include those associated with utility, transportation, finance, government, and military installations and infrastructures. Such applications were generally supported by mainframe systems because mainframes provide a large degree of data redundancy, enhanced data recoverability features, and sophisticated data security features.

As smaller “off-the-shelf” commodity data processing systems such as personal computers (PCs) increase in processing power, there has been some movement towards using such systems to support industries that historically employed mainframes for their data processing needs. For instance, one or more personal computers may be interconnected to provide access to “legacy” data that was previously stored and maintained using a mainframe system. Going forward, the personal computers may be used to update this legacy data, which may comprise records from any of the aforementioned sensitive types of applications.

For these and other reasons it has become popular to emulate a legacy OS (e.g., OS2200 from UNISYS® Corp.) on a machine operating under the primary control of a host OS, which is a commodity OS such as LINUX®. In one emulation approach, an instruction processor emulator is a program that runs under the host OS and is comprised of instructions that are native to the processor (“host processor”) of the hardware platform managed by the host OS. The emulated OS is a program comprised of instructions native to the processor that is emulated (“emulated processor”) by the instruction processor emulator. In emulating the emulated OS, many host processor instructions of the instruction processor emulator are executed in interpreting the emulated OS instructions and performing the functions of those emulated OS instructions. Thus, many host processor instructions are executed to accomplish the function of each one of the emulated instructions. This introduces significant processing overhead into the emulation process.

A method and system that address these and other related issues are therefore desirable.

### SUMMARY

The various embodiments of the invention provide methods and systems for dispatching routines in an emulated operating system. In one embodiment, a method comprises executing a first operating system (OS) on an instruction processor of a data processing system. The first OS includes instructions of a first instruction set that are native to the instruction processor. A second OS is emulated on the first OS and data processing system and includes instructions of a second instruction set that are not native to the instruction processor. The method creates a first plurality of tasks by the emulated second OS. The first plurality of tasks are individually scheduled by the first OS and are dispatched by the first OS according to the scheduling by the first OS.

A system for emulating an operating system is provided in another embodiment. The system comprises a data processing system including a first type instruction processor. The data processing system executes a first operating system (OS) that includes instructions of a first instruction set that are native to the first type instruction processor. An instruction processor (IP) emulator executes on the first type instruction processor and emulates execution of instructions of a second instruction set that are not native to the first type instruction processor. A second OS that includes instructions of the second instruction set is emulated by the emulator. The emulated OS is configured to create a first plurality of tasks to be emulated and submit the first plurality of tasks to the first OS for scheduling by the first OS. The first OS dispatches the first plurality of emulated tasks for emulation according to the scheduling by the first OS.

According to another embodiment, an emulation system comprises at least one instruction processor for executing a first operating system (OS). The first OS includes instructions of a first instruction set that are native to the instruction processor. The system further includes means for emulating a second OS on the first OS and on the at least one instruction processor. The second OS includes instructions of a second instruction set that are not native to the instruction processor. Means are provided for creating a first plurality of tasks by the emulated second OS. The system also includes means for individually scheduling the first plurality of tasks by the first OS, and means for dispatching the first plurality of emulated tasks for emulation according to the scheduling by the first OS.

The above summary of the present invention is not intended to describe each disclosed embodiment of the present invention. The figures and detailed description that follow provide additional example embodiments and aspects of the present invention.

### BRIEF DESCRIPTION OF THE DRAWINGS

Other aspects and advantages of the invention will become apparent upon review of the Detailed Description and upon reference to the drawings in which:

FIG. 1 is a block diagram of an example commodity-type data processing system such as a personal computer, workstation, or other “off-the-shelf” hardware that may be adapted for use with emdodiments of the current invention;

FIG. 2 is a block diagram of the software layers of an example emulation arrangement;

FIG. 3 is a flowchart of an example process for dispatching tasks of the emulated operating system using the dispatcher of the commodity operating system in accordance with an embodiment of the invention;

FIG. 4 is a block diagram showing the separate dispatchers in the emulated operating system and the commodity operating system;

FIG. 5 is a block diagram showing the commodity OS dispatcher performing the scheduling and dispatching of both emulated tasks and non-emulated tasks;

FIG. 6 is a flowchart of an example process for establishing and managing emulated emulated tasks as tasks that are scheduled and dispatched by the dispatcher of the commodity operating system;

FIG. 7 is a flowchart of an example process for the thread-first routine of the emulator for checking parameters of a control thread;

FIG. 8 is a flowchart of an example process for the thread-destroy routine for destroying an emulated thread that is subject to scheduling by the commodity operating system dispatcher;

FIG. 9 is a flowchart of an example process for the thread-block routine for blocking an emulated thread that is subject to scheduling by the commodity operating system dispatcher;

FIG. 10 is a flowchart of an example process for the thread-unblock routine for unblocking an emulated thread that is subject to scheduling by the commodity operating system dispatcher; and

FIG. 11 is a block diagram that shows an approach for calling a non-emulated routine from an emulated program in accordance with an embodiment of the invention;

FIG. 12 is a flowchart of an example process for calling emulated routines and non-emulated routines from an emulated program in accordance with an embodiment of the invention.

### DETAILED DESCRIPTION

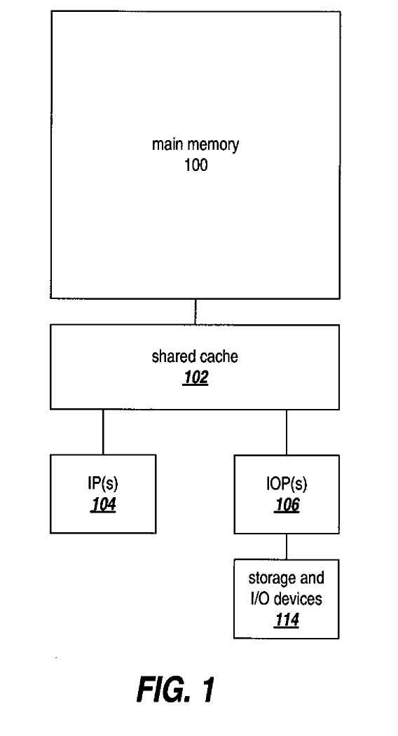

FIG. 1 is a block diagram of an example commodity-type data processing system such as a personal computer, workstation, or other “off-the-shelf” hardware (hereinafter “host platform”) that may be adapted for use with the current invention. This system includes a main memory 100, which may be optionally coupled to a shared cache 102 or some other type of bridge circuit. The shared cache is, in turn, coupled to one or more instruction processors (IPs) 104. In one embodiment, the instruction processors include commodity-type IPs such as are available from Intel Corporation, Advanced Micro Devices Incorporated, or some other vendor that provides IPs for use in host platforms.

In the example system of FIG. 1, Input/Output processors (IOPs) 106 are coupled to the shared cache 102. The IOPs provide access to mass storage and I/O devices 108, such as disk drives and data networks.

A host operating system (OS) 110 such as UNIX®, LINUX®, WINDOWS®, or any other operating system adapted to operate on a host platform is stored within main memory 100 of the illustrated system. The host OS is responsible for the management and coordination of activities and the sharing of the resources of the data processing system.

Host OS 110 acts as a host for Application Programs (APs) 112 that run on the data processing system. For instance, if an AP requires memory to perform one or more tasks, the AP makes a call to the host OS 110 for memory allocation. This call may be made via a standard application programming interface that is provided for this purpose.

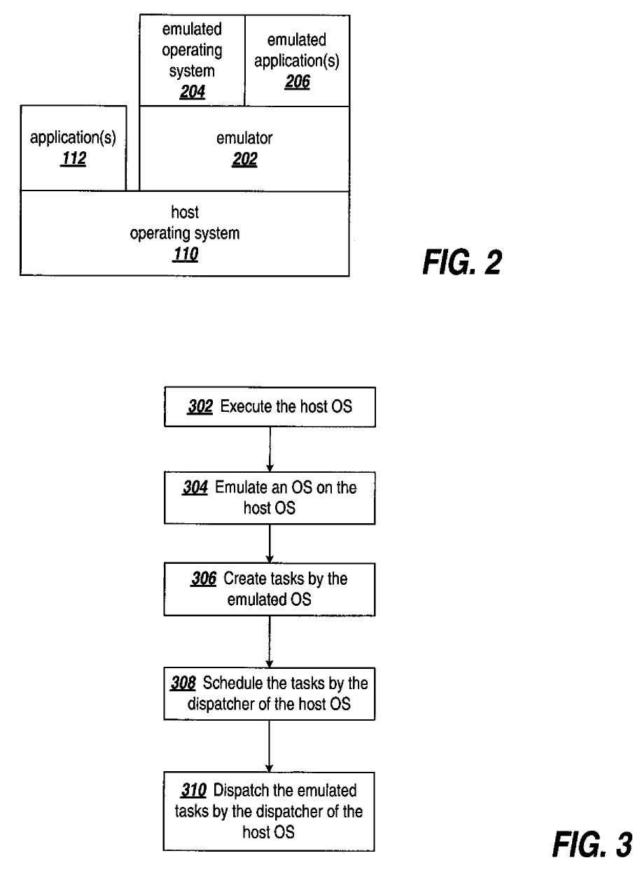

FIG. 2 is a block diagram of the software layers of an example emulation arrangement. The layers generally signify that the host OS manages the resources of the data processing system (FIG. 1) and provides services to the applications 112 and the emulator 202, the emulator emulates a non-native instruction processor executing the emulated OS 204, and the emulated OS provides services to the emulated application(s) 206.

In an example implementation, the emulated OS 204 may be the 2200 OS, which is commercially available from Unisys Corporation. Those skilled in the art will recognize other legacy OSes that are suitable candidates for emulation. The emulated OS is implemented to execute directly on a “legacy platform” (not shown), which is an enterprise-level platform such as a mainframe that typically provides the data protection and recovery mechanisms needed for applications that are manipulating critical data and/or must have a long mean time between failures. For the example 2200 OS, the corresponding emulated platform is a 2200 series data processing system, which is also commercially available from the Unisys Corporation. Alternatively, this emulated platform may be some other enterprise-level system.

In the example emulation arrangement, emulated OS 204 is comprised of a machine instruction set (hereinafter, “emulated instruction set”, or “emulated instructions”), which are different from the instruction set that is native to IP(s) 104 (FIG. 1). This emulated instruction set is the instruction set which is executed by the IPs of a emulated platform on which emulated OS was designed to operate. In this embodiment, the emulated instruction set is emulated by IP emulator 202.

IP emulator 202 may include any one or more of the types of emulators that are known in the art. For instance, the emulator may include an interpretive emulation system that employs an interpreter to decode each emulated instruction, or groups of emulated instructions. After one or more instructions are decoded in this manner, a call is made to one or more routines that are written in native mode instructions that are included in the instruction set of IP(s) 104. Such routines emulate each of the operations that would have been performed by the emulated system.

In the example embodiment, the emulator is comprised of instructions from the host processor instruction set. That is, the emulator is a program that is executable on IP(s) 104 in the data processing system of FIG. 1.

FIG. 3 is a flowchart of an example process for dispatching tasks of the emulated OS using the dispatcher of the host OS in accordance with an embodiment of the invention.

An operating system and hosted application programs are often executed as multiple processes and/or threads. Processes generally have their own address space and state while multiple threads for a particular program or application may share the program state. For purposes of the current discussion, task is used to refer to both threads and processes. To support concurrent processing of tasks (also referred to as multiprocessing or multitasking), the operating system schedules each task to execute for some period of time. When the allotted time of a task has expired, another task is selected by the operating system to execute for some period of time. The module or logic of the operating system that performs the scheduling process is often referred to as the scheduler or dispatcher.

Both the host OS and the emulated emulated OS have dispatchers. In view of the processing overhead involved in emulating the instructions of the emulated instruction set, emulating the dispatcher part of the emulated OS is especially inefficient given the frequency with which the dispatcher is emulated to schedule emulated tasks. Thus, in accordance with one embodiment, emulated tasks of the emulated OS are scheduled and dispatched by the dispatcher of the host OS. This technique may be used to eliminate much of the overhead associated with emulating the emulated dispatcher. That is, some functionality of the emulated dispatcher is replaced by a control thread. But most of the dispatcher work is performed by the host OS dispatcher with execution of native mode instructions, which are not emulated.

At step 302, the host OS is executed, and the emulated OS is emulated on the host OS at step 304. In the normal course of emulating the emulated OS, the emulated OS may create multiple tasks which are either used by it in managing its operating environment or are tasks associated with emulated application programs. These emulated tasks are provided to the dispatcher of the host OS which schedules them at step 308. At step 310, the host OS dispatcher dispatches the emulated tasks for execution/emulation. In one embodiment, the host OS dispatcher does so by providing the emulator 202 (FIG. 2) with the information needed to emulate the selected task, such as the address of the next instruction to emulate for that task.

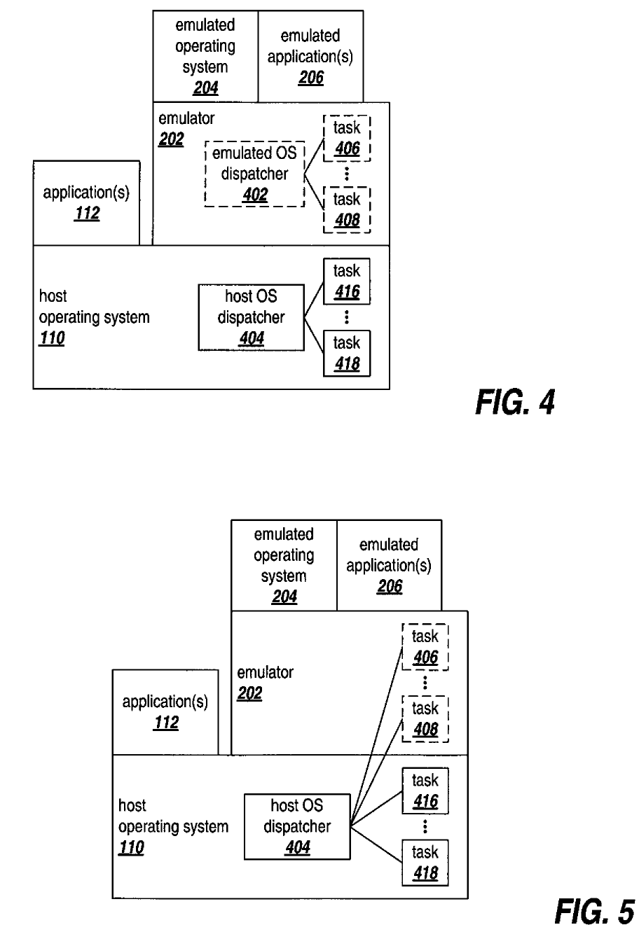

FIG. 4 is a block diagram showing the separate dispatchers in the emulated OS and the host OS. The emulated OS dispatcher 402 schedules and dispatches tasks controlled by the emulated OS, and the host OS dispatcher 404 schedules and dispatches tasks controlled by the host OS. The dashed lines of blocks 402, 406, and 408 for the emulated OS dispatcher and tasks signify that program code of the emulated OS 204 and/or emulated application(s) 206 is emulated. The solid lines of blocks 404, 416, and 418 signify the execution of native instructions.

The emulated OS dispatcher 402 is part of the emulated OS 204 that is emulated by emulator 202. In emulating the emulated OS, the emulated OS will start multiple tasks 406-408, and the emulated dispatcher 402 will schedule and dispatch those tasks for execution/emulation. Thus, each time the emulated dispatcher 402 is invoked by the emulated OS 204 to perform scheduling/dispatching activities, the code of the emulated dispatcher is emulated. This may occur quite frequently if there are large number of tasks and the allotted time periods are small.

The host OS dispatcher 404 is part of the host OS 110. Tasks 416-418 are started by the host OS in performing its processing and in providing services to applications 112, as well as to emulator 202, which is essentially a particular one of applications 112. Thus, one or more of tasks 416-418 would correspond to the emulator 202 since the emulator is a program running under the host OS 110.

In the scenario illustrated in FIG. 4, the host dispatcher 404 has no visibility of emulated tasks 406-408. Thus, the emulated emulated dispatcher 402 selects which of tasks 406-408 is next to execute/emulate, but it is not until host OS dispatcher 404 selects the task for emulator 202 to execute (as one of tasks 416-418) that the selected one of tasks 406-408 can be actually executed/emulated.

FIG. 5 is a block diagram showing the host OS dispatcher performing the scheduling and dispatching of both emulated tasks and non-emulated tasks. In one embodiment, the emulated OS 204 and emulator 202 are adapted to call on the host OS 110 to recognize emulated tasks and schedule/dispatch those tasks. The emulated OS 204 is specifically configured to indicate to the emulator 202 when the emulator should call on the host OS 110 to manage the specified tasks of the emulated OS.

From FIG. 5 it may be observed that the emulated tasks 406-408 are scheduled and dispatched by the host OS dispatcher 404 instead of the emulated OS dispatcher 402 as in FIG. 4. Thus, the emulated OS dispatcher 402 need not be emulated to schedule the execution/emulation of tasks 406-408. The host OS dispatcher effectively schedules and dispatches the emulated tasks 406-408 along with the tasks 416-418.

The set of emulated tasks selected to be managed by the host OS dispatcher depends on implementation requirements and objectives. If all emulated tasks are managed by the host OS dispatcher, then the emulated OS dispatcher may be eliminated from the emulation. However, some implementations may require that some emulated tasks be managed by the emulated OS dispatcher and others managed by the host OS dispatcher. In this instance, the emulated OS dispatcher would schedule/dispatch some emulated tasks and the host OS dispatcher would schedule/dispatch other emulated tasks.

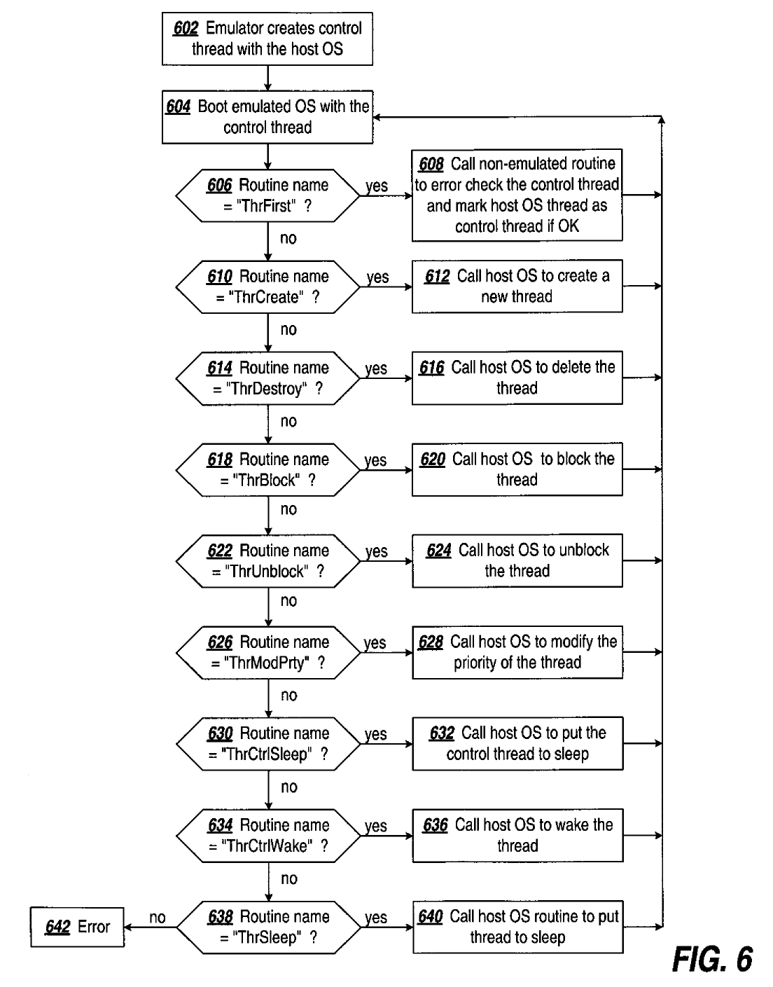

FIG. 6 is a flowchart of an example process for establishing and managing emulated emulated tasks as tasks that are scheduled and dispatched by the dispatcher of the host OS. In an example embodiment, the tasks that are established with the emulated OS dispatcher are threads.

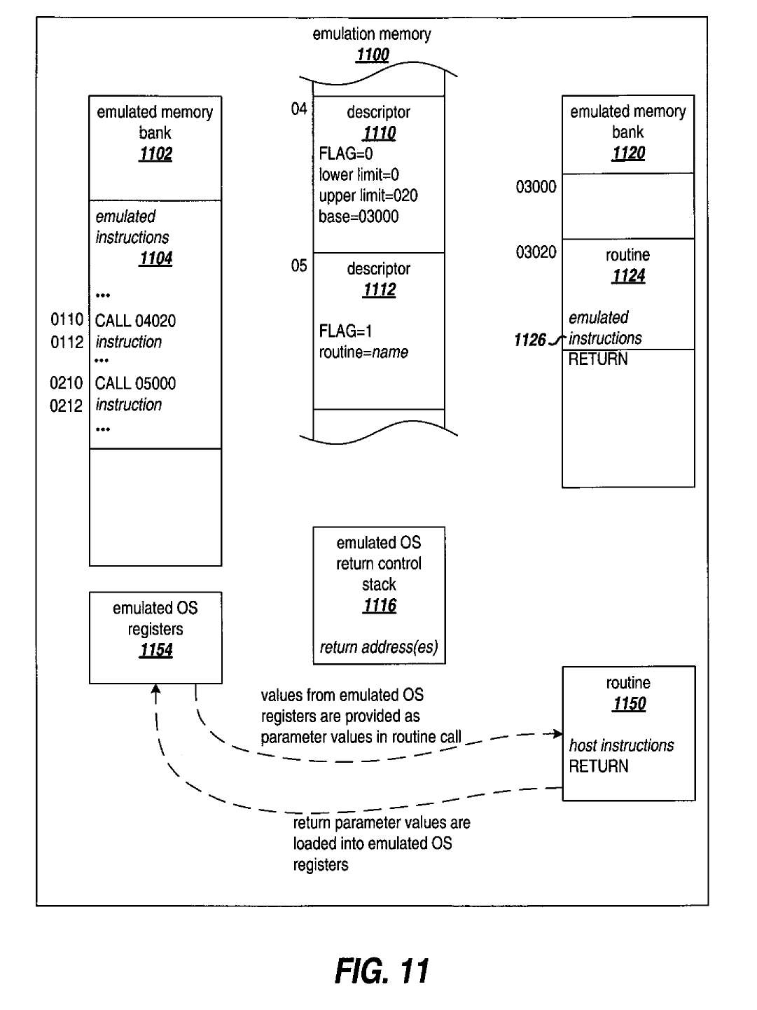

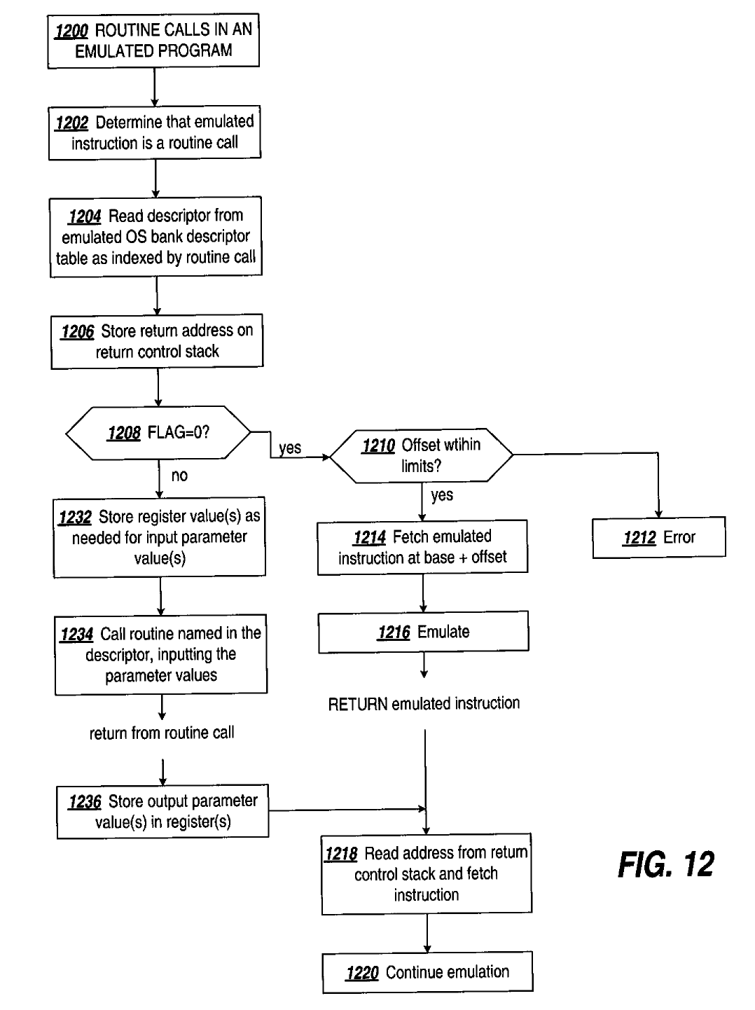

At step 602, the emulator begins executing and creates a control thread for use in booting the emulated host OS. The control thread is one of the tasks managed by the host OS dispatcher. The emulator proceeds to boot the emulated OS using the control thread at step 604. During the boot process, the emulator emulates the booting of the emulated OS, and in the boot process the emulated OS creates and manages a number of threads. In booting the emulated OS on its native hardware platform, the emulated OS dispatcher would be called upon to create and manage these threads. In an embodiment according to the present invention, however, the emulated emulated OS signals to the emulator that a thread is to be created with the host OS dispatcher, instead of calling the emulated emulated OS dispatcher. In response, the emulator calls thread control routines of the host OS for managing threads. The mechanism is further described in FIGS. 11 and 12.

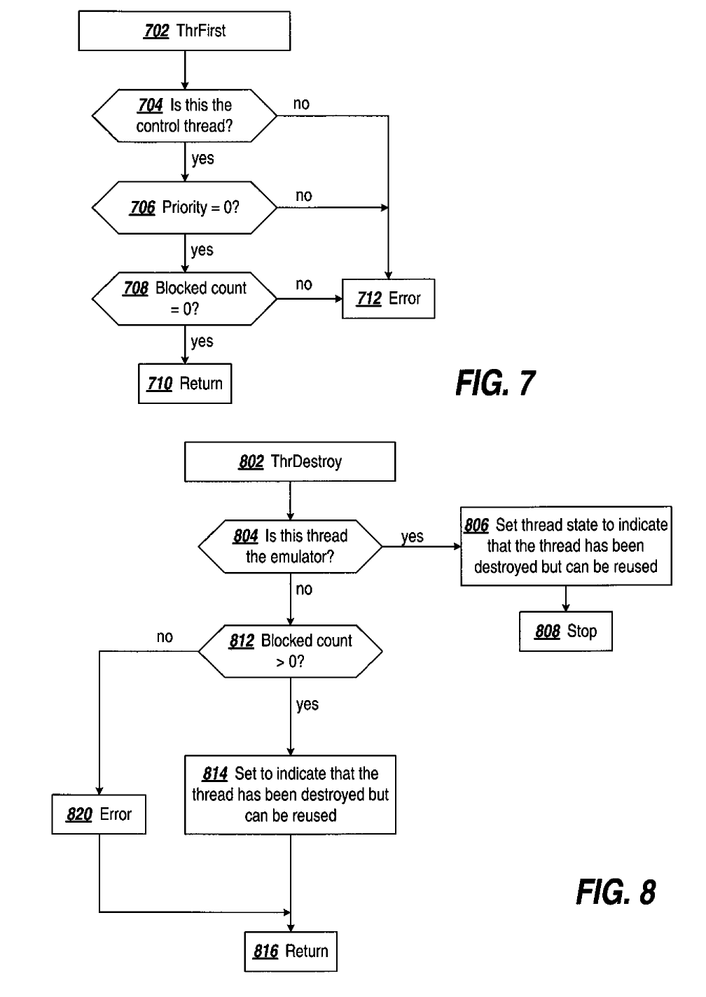

There are a number of routines available to the emulated OS for submitting threads to the host OS dispatcher. These routines are invoked during the boot of the emulated OS (and after booting for other threads) and are shown and described in FIG. 6. If the routine name specified by the emulated OS to the emulator is ThrFirst, decision step 606 directs the process to step 608. For the ThrFirst routine, the emulated OS provides the emulated OS thread identifier of the control thread, and the emulator calls the host OS at step 108, which performs some error checking for the control thread. If control is returned, the emulator designates the host OS thread identifier with the control thread for purposes of indicating which host OS thread identifier is the control thread. Further description of the ThrFirst routine is provided in FIG. 7.

If the routine name is ThrCreate, decision step 610 directs the emulator to step 612 where the emulator calls the appropriate routine of the host OS to create a thread. The emulated OS provides the state of its registers to initialize the thread, including a emulated OS thread identifier, a priority value, and starting emulated OS virtual address for the thread. The host OS and emulator return a host OS thread identifier to the emulated OS. The blocked count of the thread is set to the value 1, which indicates that the thread is not to be awakened by the host OS dispatcher until it is unblocked (unblocked=0).

If the routine name is ThrDestroy, decision step 614 directs the emulator to step 616 where the emulator calls the host OS ThrDestroy routine for removing the thread. The emulated OS provides the host OS thread identifier as input and no output is returned. The ThrDestroy routine performs some error checking for the control thread and destroys the thread. Further description of the ThrDestroy routine is provided in FIG. 8.

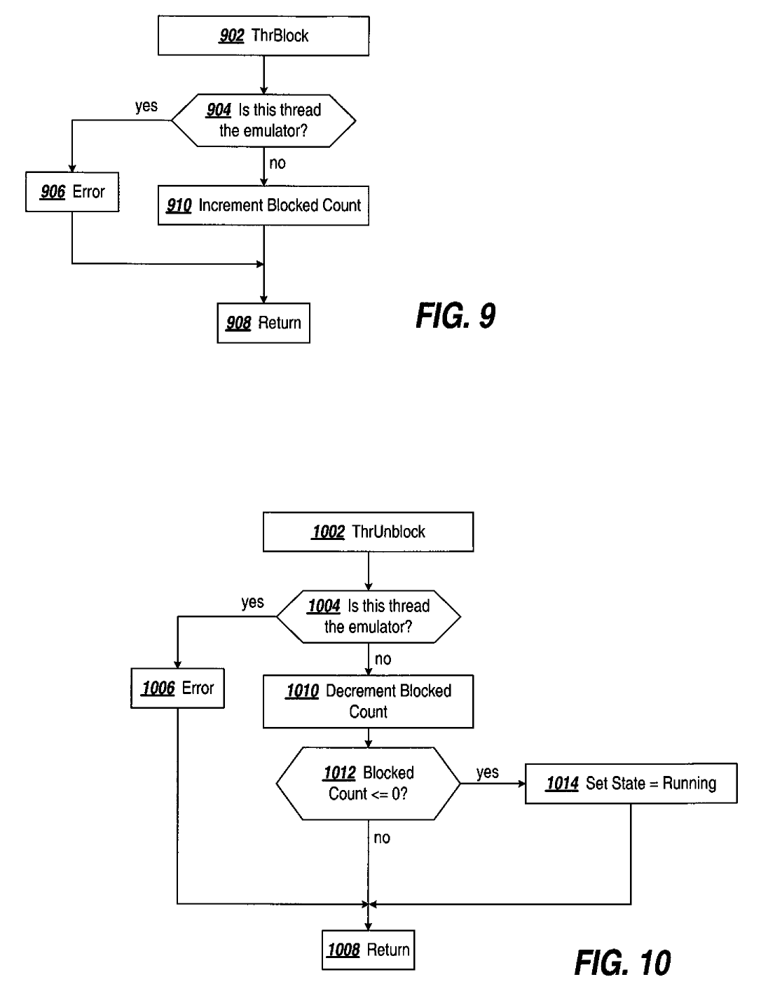

In response to the routine name being ThrBlock, decision step 618 directs the emulator to step 620, and the emulator calls the host OS ThrBlock routine. The emulated OS provides the host OS thread identifier, and the ThrBlock routine generally increments the blocked count and calls the appropriate routine of the host OS to block the thread. Further description of the ThrBlock routine is provided in FIG. 9.

For the routine name being ThrUnblock, decision step 622 directs the emulator to step 622 where the emulator calls the host OS ThrUnblock routine. The emulated OS provides the host OS thread identifier, and the ThrUnblock routine generally decrements the blocked count and calls the appropriate routine of the host OS to unblock the thread. Further description of the ThrUnblock routine is provided in FIG. 10.

If the routine name is ThrModPrty, decision step 626 directs the emulator to step 628 and there the emulator calls the host OS routine for modifying the thread priority. The emulated OS provides the host OS thread identifier and a value for the desired priority.

In response to the routine name being ThrCtrlSleep, decision step 630 directs the emulator to step 632, and the emulator calls the host OS routine for putting the control thread to sleep. The emulated OS provides a value indicating the time for which the thread is not to be considered for execution/emulation. The emulated OS may also provide a value indicating a new priority level for the control thread.

In response to the routine name being ThrCtrlWake, decision step 634 directs the emulator to step 636, and the emulator calls the host OS routine for waking the control thread.

For the routine name ThrSleep, decision step 638 directs the emulator to step 640. At step 640, the emulator calls the host OS to put the thread to sleep. The emulated OS provides a value indicating the time for which the thread is not to be considered for execution/emulation. The emulated OS need not provide the thread identifier of the thread to put to sleep because the thread identifier of the caller is the thread to be put to sleep.

After returning to the emulator from calling the described thread control routines, the emulator returns to step 604 to continue booting the emulated OS. An error is detected if the routine name provided by the emulated OS does not match any of the those recognized by the emulator as shown by step 642.

FIG. 7 is a flowchart of an example process for the ThrFirst routine 702 of the emulator for checking parameters of a control thread. The purpose of the ThrFirst routine is to check for errors prior to establishing the control thread of the emulated OS At decision step 704, the emulator checks whether it is the control thread that is calling the ThrFirst routine. If so, decision step 706 checks whether the thread's priority level is 0. If tests 704 and 706 pass, and decision step finds that the blocked count=0, then the ThrFirst routine returns control to the emulator at step 710. If any of the error checks fail, an error is detected and handled at step 712.

FIG. 8 is a flowchart of an example process for the ThrDestroy routine 802 for destroying an emulated thread that is subject to scheduling by the host OS dispatcher.

When the emulated OS calls the ThrDestroy routine it inputs the host OS thread identifier of the thread to destroy. The ThrDestroy routine may also be entered by the emulator thread, bypassing the routine call mechanism (e.g., a GOTO), in which case the thread identifier is 0 for the calling emulator thread. If it is the emulator thread calling the ThrDestroy routine, decision step 804 directs the process to step 806 where the thread state is set to indicate that the thread has been destroyed but can be reused. The emulator stops at step 808.

If the thread is not that of the emulator thread, decision step 812 checks whether the blocked count is greater than 0. If the blocked count is greater than 0 (indicating that the thread is blocked) decision step 812 directs the process to step 814 where the thread state is set to indicate that the thread has been destroyed but can be reused. Control is returned to the emulator at step 816. If the blocked count is less than or equal to 0, an error condition is handled at step 820, and then control is returned to the emulator.

FIG. 9 is a flowchart of an example process for the ThrBlock routine 902 for blocking an emulated thread that is subject to scheduling by the host OS dispatcher.

When the emulated OS calls the ThrBlock routine it inputs the host OS thread identifier which is to be blocked. The ThrBlock routine may also be entered by the emulator, bypassing the routine call mechanism (e.g., a GOTO), in which case the thread identifier is 0 for the emulator. If it is the emulator thread calling the ThrBlock routine, decision step 904 directs the process to step 906 where an error condition is handled before returning control to the emulator at step 908.

If the thread is not the emulator thread, the process proceeds to step 910 where the blocked count is incremented, and control is then returned to the emulator at step 908.

FIG. 10 is a flowchart of an example process for the ThrUnblock routine 1002 for unblocking an emulated thread that is subject to scheduling by the host OS dispatcher.

When the emulated OS calls the ThrUnblock routine it inputs the host OS thread identifier which is to be unblocked. The ThrUnblock routine may also be entered by the emulator, bypassing the routine call mechanism (e.g., a GOTO), in which case the thread identifier is 0 for the emulator. If it is the emulator thread calling the ThrUnblock routine, decision step 1004 directs the process to step 1006 where an error condition is handled before returning control to the emulator at step 1008.

If the thread is not the emulator thread, the process proceeds to step 1010 where the blocked count is decremented. If the blocked count is less than or equal to 0, decision step 1012 directs the process to step 1014 to set the state of the thread to running. Control is then returned to the emulator at step 1008. If the blocked count is greater than 0 after the decrementing, control is returned to the emulator without performing step 1014.

FIG. 11 is a block diagram that shows an approach for calling a non-emulated routine from an emulated program in accordance with an embodiment of the invention. This may be useful, for example, for the emulated OS calling the thread management routines as described above. Example data structures for accomplishing the control transfer are shown in the emulation memory 1100, which is a portion of the main memory 100 (FIG. 1) allocated for emulating the emulated OS. The example shown in FIG. 11 contains both a call to an emulated routine and a call to a non-emulated routine. The same emulated OS data structures are used to support the calls to these routines. The discussion that follows first describes an example call to an emulated routine followed by a description of an example call to a non-emulated routine.

The emulation memory includes a emulated memory bank 1102 which has emulated instructions 1104 of an example program. The instructions include two routine calls, one at virtual address 0110 and the second at virtual address 0210. In decoding the CALL instruction at address 0110, the emulator determines that it is a transfer of control instruction and uses the operand 04020 to determine the target of the transfer. The “04” portion of the operand is an index to a bank descriptor table, a portion of which is shown with bank descriptors 1110 and 1112. The “04” is an index that references bank descriptor 1110.

Generally, the bank descriptor is used to determine the target of the transfer-of-control instruction. The emulator reads bank descriptor 1110 and stores the return address 0112 on the return control stack 1116. The state of the FLAG field in the bank descriptor indicates whether the target routine is an emulated routine or a non-emulated routine. When FLAG=0, the target routine is an emulated routine, and the lower and upper limits in the bank descriptor specify the range of offsets from the base address of the routine to where control can be transferred.

The emulator compares the second part (“020”) of the operand (“04020”) to the lower and upper limits of the bank descriptor 1110 for a range check. Since the offset is within the specified range, the emulator adds the offset 020 the base 03000 to determine the target address of 03020. The emulator then fetches, decodes, and emulates the instruction at address 03020, which is in emulated memory bank 1120 and part of routine 1124. When the emulator emulates the RETURN instruction 1126, the return address is fetched form the return control stack 1116, which in the current example holds address 0112. The emulator then fetches the instruction at address 1112 to complete the return of control.

The emulated instructions 1104 may also call a non-emulated routine via the bank descriptor mechanism. The CALL instruction at address 0210 is an example of such a call. The first portion (“05”) of the operand 05000 references bank descriptor 1112. The emulator reads bank descriptor 1112 and stores the return address 0212 on the return control stack 1116. Bank descriptor has FLAG=1, which indicates to the emulator that the target routine is a non-emulated routine, and instead of having lower and upper limits and a base address, the bank descriptor contains a routine name following the FLAG value.

The emulator stores selected register values from the emulated OS registers 1154 as parameters to be provided as input to the target routine, and the emulator then calls the routine 1150, which is named in the bank descriptor 1112. When control is returned to the emulator by the called routine 1150, the emulator stores the returned parameter values in the emulated OS registers 1154 and reads the return address 0212 from the return control stack 1116. The emulator then fetches the instruction at address 0212 from the emulated memory bank 1102.

FIG. 12 is a flowchart of an example process 1200 for calling emulated routines and non-emulated routines from an emulated program in accordance with an embodiment of the invention. At step 1202, the emulator determines that an emulated instruction is a routine call. In the example shown in FIG. 11, an instruction such as the CALL instruction is a routine call. In response to determining that the emulated instruction is a routine call, at step 1204, the emulator reads a bank descriptor from the emulated bank descriptor table as indexed by the operand of the instruction. The return address is stored on the emulated OS return control stack at step 1206.

Decision step 1208 tests the value of the FLAG in the bank descriptor. If FLAG=0, decision step 1210 determines if the offset portion of the instruction operand is within the lower and upper limits specified in the bank descriptor. An offset outside these limits is an error and the emulator handles the error, for example, by stopping execution, at step 1212.

If the offset is within the specified limits, the emulator at step 1214 fetches the emulated instruction at the address that is the base value (from the bank description) plus the offset (from the operand). The emulator emulates the instruction, along with other instructions in the routine, at step 1216. Upon encountering a RETURN emulated instruction in the emulated routine, the emulator at step 1218 reads the address from the return control stack and fetches the instruction at that address. The general emulation of the program continues at step 1220.

If FLAG=1, decision step 1208 directs the emulator to step 1232 to transfer control to a non-emulated routine. At step 1232, the emulator stores the contents of selected emulated OS registers as parameters to be input to the non-emulated routine. The emulator then directly calls the non-emulated routine, as named in the bank descriptor, at step 1234. The parameters, which contain the contents of the selected emulated OS registers, are provided as input to the routine by the emulator in the call to the routine.

Upon return of control to the emulator, at step 1236, the emulator stores the values of output parameters back into selected emulated OS registers. The emulator then continues processing at step 1218 as described above.

Those skilled in the art will appreciate that various alternative computing arrangements, including one or more processors and a memory arrangement configured with program code, would be suitable for hosting the processes and data structures of the different embodiments of the present invention. In addition, the processes may be provided via a variety of computer-readable storage media or delivery channels such as magnetic or optical disks or tapes, electronic storage devices, or as application services over a network.

The present invention is thought to be applicable to a variety of emulation systems. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A method for dispatching routines in an emulated operating system, comprising:
executing a first operating system (OS) on an instruction processor of a data processing system, wherein the first OS includes instructions of a first instruction set that are native to the instruction processor;
emulating a second OS on the first OS and data processing system, wherein the second OS includes instructions of a second instruction set that are not native to the instruction processor;
creating a first plurality of tasks by the emulated second OS;
individually scheduling the first plurality of tasks by the first OS; and
dispatching the first plurality of emulated tasks for emulation according to the scheduling by the first OS.

2. The method of claim 1, wherein the creating includes invoking routines of the first OS by an emulator in response to task control operations invoked by the emulated the second OS.

3. The method of claim 2, wherein the invoking of routines of the first OS includes emulating a transfer-of-control instruction of the second set.

4. The method of claim 2, wherein the tasks are threads.

5. The method of claim 4, wherein the task control operations include create thread and destroy thread operations.

6. The method of claim 5, wherein the task control operations include block and unblock thread operations.

7. The method of claim 5, wherein the task control operations include sleep and wake thread operations.

8. The method of claim 1, further comprising:
creating a second plurality of tasks by the emulated second OS;
individually scheduling the second plurality of tasks by the second OS; and
dispatching the second plurality of emulated tasks for emulation according to the scheduling by the second OS.

9. The method of claim 1, further comprising:
storing in a table, names of task control routines of the first OS;
emulating a transfer-of-control instruction of the second set, wherein the emulated transfer-of-control instruction includes an operand, and the operand includes an index into the table;
wherein the creating includes an emulator reading one of the names of task control routines from the table as referenced by the index from the operand and invoking the task control routine with the one of the names.

10. A system for emulating an operating system, comprising:
a data processing system including a first type instruction processor, wherein the data processing system executes a first operating system (OS) that includes instructions of a first instruction set that are native to the first type instruction processor;
an instruction processor (IP) emulator executing on the first type instruction processor, wherein the IP emulator emulates execution of instructions of a second instruction set that are not native to the first type instruction processor, and the IP emulator emulates a second OS that includes instructions of the second instruction set;
wherein the emulated OS is configured to create a first plurality of tasks to be emulated and submit the first plurality of tasks to the first OS for scheduling by the first OS; and
wherein the first OS dispatches the first plurality of emulated tasks for emulation according to the scheduling by the first OS.

11. The system of claim 10, wherein the emulator is further configured to invoking routines of the first OS in response to task control operations invoked by the emulated the second OS.

12. The system of claim 11, wherein the invoking of routines of the first OS is in response to emulating a transfer-of-control instruction of the second set.

13. The system of claim 11, wherein the tasks are threads.

14. The system of claim 13, wherein the task control operations include create thread and destroy thread operations.

15. The system of claim 14, wherein the task control operations include block and unblock thread operations.

16. The system of claim 14, wherein the task control operations include sleep and wake thread operations.

17. The system of claim 10, wherein the emulated second OS is further configured to create a second plurality of tasks, individually schedule the second plurality of tasks, and dispatch the second plurality of emulated tasks for emulation according to the scheduling by the second OS.

18. The system of claim 10, further comprising:
a table stored in a memory of the data processing system, the memory coupled to the first type instruction processor and the table having names of task control routines of the first OS;
wherein the emulator is further configured to emulate a transfer-of-control instruction of the second set, the emulated transfer-of-control instruction includes an operand, and the operand includes an index into the table;
wherein the emulator is further configured to read one of the names of task control routines from the table as referenced by the index from the operand and invoke the task control routine with the one of the names.

19. An emulation system, comprising:
at least one instruction processor for executing a first operating system (OS), wherein the first OS includes instructions of a first instruction set that are native to the instruction processor;
means for emulating a second OS on the first OS and on the at least one instruction processor, wherein the second OS includes instructions of a second instruction set that are not native to the instruction processor;
means for creating a first plurality of tasks by the emulated second OS;
means for individually scheduling the first plurality of tasks by the first OS; and
means for dispatching the first plurality of emulated tasks for emulation according to the scheduling by the first OS.
